(19) United States
(12) Patent Application Publication
(10) Pub. No.: US 2004/0114728 A1
(43) Pub. Date: Jun. 17, 2004

(54) Method and device for constructing an image in a spatial volume

(76) Inventors: Wolfgang Schlegel, Heidelberg (DE); Matthias Ebert, Edingen-Neckarhausen (DE); Jurgen Hesser, Heidelberg (DE); Boris Schadler, Havixbeck (DE)

Correspondence Address: WILLIAM COLLARD, COLLARD & ROE, P.C., 1077 NORTHERN BOULEVARD, ROSLYN, NY, 11576, US

(21) Appl. No.: 10/470,494

(22) PCT Filed: Jan. 26, 2002
(86) PCT No.: PCT/DE02/00266

(30) Foreign Application Priority Data
Jan. 29, 2001 (DE) 101 04 596.4
Mar. 13, 2001 (DE) 101 11 827.9

(51) Int. Cl. H05G 1/60

(52) U.S. Cl. 378/901

(57) ABSTRACT

The invention relates to a method and a device for reconstructing an image in a spatial volume on the basis of acquired projections, wherein during a reconstruction step each acquired projection or each region of an acquired projection is fed once into a data processing system from a memory for the acquired projections and the intensity of a voxel of the reconstructed spatial volume image is updated during the reconstruction step for each voxel relevant projection or region.

The invention relates to a method and a device for reconstructing an image in a spatial volume on the basis of acquired projections.

The generation of three-dimensional data from projections has been implemented for the medical sector, for example in computer tomography systems (CTs). As a rule, special multi-processor systems are used for image construction on the basis of the projections taken here, in order to achieve acceptable reconstruction times of a few seconds per reconstructed slice, whereby in conventional CT equipment, imaging takes place slice by slice, while more recent CT equipment is capable of scanning up to four slices at a time, by means of multi-line detectors.

In the meantime, great interest has arisen in using conventional X-ray systems for tomographic imaging as well. For one thing, an entire volume can be scanned at once, because of the cone-beam geometry and the use of extended two-dimensional detectors. For another thing, the costs for conventional X-ray systems are lower, particularly since it is not necessary to specifically procure a CT, and the resolutions that can be achieved in this connection are generally higher.

As a rule, a back-projection algorithm is used for image reconstruction on the basis of the projections obtained in this connection. Here, the gray-value data contained in the projections is uniformly distributed along a beam from the projection pixel to the radiation source, for each projection image, and weighted with a geometric distance factor. Among other things, such back-projections are used in connection with a filtered projection, in which the projection data are weighted dependent on location at first, and subjected to filtering, and then back-projected in a volume data set that is initialized with zero. Furthermore, the back-projection can also comprise iterative methods, in which a projection as well as a back-projection operation are contained in every step. After completion of the image reconstruction, the volume data can be read out from a memory for the reconstructed spatial volume image and, depending on the application, can immediately be visualized in the form of slices or also in three dimensions.

It has been shown that the times required in this connection are significant; for example, a data volume with a size of 2563 can be reconstructed in approximately 15 minutes by means of a Feldkamp algorithm. In the case of iterative reconstruction methods, this time is extended approximately by the number of required iterations, which typically lie in the range of several tens of steps. However, such computing times are far removed from a real-time reconstruction, and are not acceptable, particularly if the corresponding devices are supposed to be used together with position monitoring.

There are approaches to shorten the required computing times. For example, T. Bortfeld, in “Optimized planning using physical objectives and constraints,” Sem. in Rad. Onc., 9: 20-34 (1999), assuming a parallel beam geometry and a common axis of rotation, proposes utilizing the property of radon transformation, that the projection represents a plane of the Fourier transform of the volume, so that the back-transformation is obtained by new scanning in the Fourier space and back-transformation (Fourier slice theorem). However, this possibility is limited only to the geometries described. Furthermore, there is the possibility of increasing the computing speed by parallelizing the algorithm. According to Sasaki, T., Fukuda, Y., in “Reconstruction of 3-D X-ray computerized tomography images using a distributed memory multiprocessor system,” transaction of the information processing society of Japan, vol. 38, no. 9, Sept. 1997, pages 1681 to 1693, and according to Dehner, G., Herbert, M. in “Vector computing in CT image reconstruction algorithm, data rate, compute power, parallel processing,” in SPEEDUP, vol. 9, no. 2, December 1995, pages 41 to 47 (Switzerland), such parallelization is possible without problems. However, it has turned out that with such parallelization, the output unfortunately increases in almost linear manner, since the method is essentially memory-limited. The actual computing operation generally runs faster than the reading of the required data. Since the computing speed of the processors is becoming ever greater, while the memory bandwidth (the number of data that can be read out per time unit) is increasing only slowly, this ratio is becoming more disadvantageous. In this regard, any desired output increase is theoretically possible by means of parallelization, but this can be implemented only at the expense of an extreme increase in the costs of the hardware. An alternative is to use special hardware for the reconstruction. For example, Ajakuijala, J., Jaske, U. M., Sallinen, S., Hehimen, H., Laitinen, J., in “Reconstruction of digital radiographs by texture mapping, ray casting and splatting,” Proceedings of the 18th Annual International Conference of the IEEE Engineering in Medicine and Biology Society, “Bridging Disciplines for Biomedicine” Cat. No. 96CH36036) IEEE. Part vol. 2, 1997, pages 643 to 645 vol. 2, New York, N.Y., USA, were able to explain that the CT reconstruction can be accelerated by means of texture mapping on 3D graphics cards (open GL implementation). However, such systems are suitable only for parallel processing with certain restrictions, and cannot be scaled. Furthermore, according to Tresp, V., Snell, R., Gmitro, A. F., in “Videographic tomography II reconstruction with fan-beam projection data,” IEEE transaction on medical imaging, vol. 13, no. 1, March 1994, pages 137 to 143, USA, there is the possibility of optically resolving the computing-intensive part, but this cannot be implemented in practice.

It is the task of the present invention to make available a method and a device for reconstructing an image in a spatial volume on the basis of acquired projections, with which the highest possible processing resolution is achieved with minimal hardware expenditure.

This task is accomplished, on the one hand, by means of a method for reconstructing an image in a spatial volume on the basis of acquired projections, wherein during a reconstruction step, each acquired projection is fed once into a data processing unit from a memory for the acquired projections, and the intensity of a voxel of the reconstructed spatial volume image is updated during the reconstruction step for each voxel-relevant projection. In this manner, it is possible to minimize the number of projections to be loaded, and thereby to reduce the total time for implementation of the method to a minimum, by reducing the number of the most time-consuming memory actions, namely reading in projection data.

In this connection, however, the important factor is not, as it is in the method according to DE 42 24 568 A1 for example, to develop a two-dimensional shaded image from a three-dimensional data set, but rather the three-dimensional data set is supposed to be determined from the individual projections.

Depending on the relative position of the projection planes with regard to one another, it can be advantageous to handle only regions of a projection plane accordingly, instead of the entire projection plane, in each instance. Accordingly, it would then be necessary to select the voxels of different regions and to use them for the reconstruction step, in each instance, in case of a change in the location of the voxels. In this connection, it is understood that depending on the location of these regions, certain regions of a projection plane will be handled in this manner more than once, whereby according to the invention, each region in its particular form is only supposed to be loaded once. In particular, the total need for hardware can be reduced in this manner, since only the memory space that is absolutely necessary for storing the relevant data contained in the projections must be kept available. This method of procedure, in particular, reduces the required memory for a temporary memory, i.e. a cache, in which these data can be kept available.

On the other hand, this task is accomplished by means of a device for reconstructing an image in a spatial volume on the basis of acquired projections, having a memory for the acquired projections and a memory for the reconstructed spatial volume image, wherein these memory units are linked with one another by means of a data processing unit, and which is characterized in that the data processing unit comprises at least two processing pipelines, which are each connected with at least one memory region of a projection cache for a projection, or a region of a projection, on the one hand, and with at least one memory region of a voxel cache, on the other hand, whereby the voxel cache is linked with the memory for the reconstructed spatial volume image, and the projection cache is linked with the memory for the acquired projections.

The method described above can be carried out on such a device, for example, whereby the processing speed already lies clearly above the speeds of conventional systems. On the other hand, a different method of procedure is also possible on such a system, while maintaining this advantage.

Preferably, several projections or regions of these projections are therefore processed in parallel, so that these simply have to be loaded once, whereby all of the relevant voxels are processed in accordance with the reconstruction defaults, in particular in such an arrangement, for the projection or region of a projection that has been loaded once.

In particular, in a sub-step of the reconstruction, a sub-cube of the voxel space can be processed, whereby such a sub-cube is stored in the voxel cache, for reasons of effectiveness and therefore speed. By storing the sub-cube in the cache, these intensity data are available in the cache for assessment, and it is not necessary to derive the data in question from the actual memory for the reconstructed spatial volume image, which is normally very time-consuming, because of the size of the latter. In a method conducted in this way, a special algorithm or a special hardware structure can be used for filling the cache.

Processing of the entire spatial volume image in the form of suitably selected sub-cubes can advantageously increase the processing speed, even independent of the way in which the method is carried out for the remainder, particularly in interplay with several processing pipelines or the parallel computer structure described above, but also independent of these. This is particularly true if the corresponding voxel cache is structured as a shift register.

As already indicated above, it can be advantageous to first process a selection of voxels, in a reconstruction sub-step, the projections of which are imaged on a similar region of a projection plane. In this way, the projection data that exist in this region can be made available in a relatively small memory, particularly in a cache, whereby the processing time is reduced by means of a cache, independent of the remainder of how the method is carried out according to the invention, i.e. independent of the other characteristics of the device described, since such a cache demonstrates significantly lower access times for a computer unit connected with it.

For example, the corresponding region can be determined in that the voxels in question are projected onto the projection plane, in each instance, and that the covered area, in each instance, is utilized.

Preferably, this selection of voxels is a previously described sub-cube, thereby causing the advantages of the aforementioned solution approaches to become cumulative. It is understood that the sub-cubes do not necessarily have to have a cubical shape, and instead, any amount of voxels, preferably any simply connected amount of voxels, can be used if this makes it possible to reduce the number of projections or regions that are required consecutively for a sequence of specific reconstruction steps.

The use of a voxel cache is also advantageous independent of a projection cache or a parallel computer structure, since it is possible to reduce the access times of the computer unit by means of such a cache, since a large main memory, as it is required for recording the entire reconstructed image data, demonstrates significantly slower access times.

In order to further reduce the processing time, a second voxel cache can be provided, which can be connected with the processing pipeline, as an alternative to the first voxel cache, and can exchange data with the memory for the reconstructed spatial volume image, independent of the first voxel cache. In this regard, one of the two voxel caches can exchange data with the memory for the reconstructed spatial volume image, while the other voxel cache is utilized for the computing operation. Once the computing process has been completed, these connections can be changed by a simple switch. In this way, dead times resulting from the data exchange between the voxel cache and the memory for the reconstructed spatial volume image are avoided.

Furthermore, the invention proposes a device for reconstructing the image of a spatial volume on the basis of acquired projections, having a memory for the acquired projections and a memory for the reconstructed spatial image, which are linked with one another by way of a data processing unit, wherein the memory bandwidth lies below the processing output of the total system. A device set up in this way is able to work faster than the memories allow, and thereby causes the hardware to be optimally utilized. Preferably, the memory bandwidth and the processing output are compared in voxels/second, whereby other criteria that allow a comparison between the output of the memory units for the reconstructed spatial volume image and for the acquired projections and the processing outputs are possible.

It is understood that in the present connection, the term “spatial volume image” comprises any representation in which data contained in the projections are reconstructed in three dimensions and stored in memory.

In particular, this can also be related to an intensity distribution in a voxel space. The same also holds true for the “projections.”

Other properties, goals and advantages of the invention will be explained below, using the drawings attached to the following description, in which method steps according to the invention as well as a computer architecture are explained as examples. The drawing shows:

FIG. 1 a schematic representation of an X-ray system;

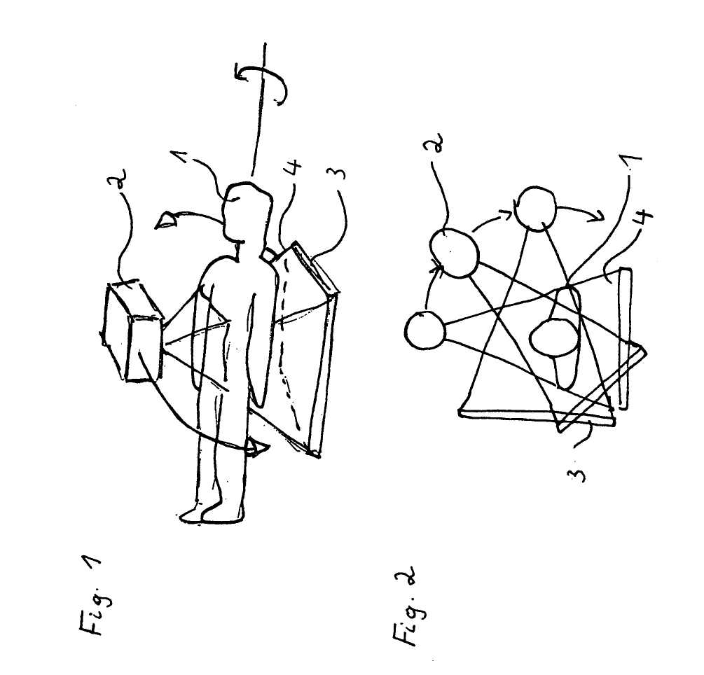

FIG. 2 the X-ray system according to FIG. 2 [sic] in cross-section;

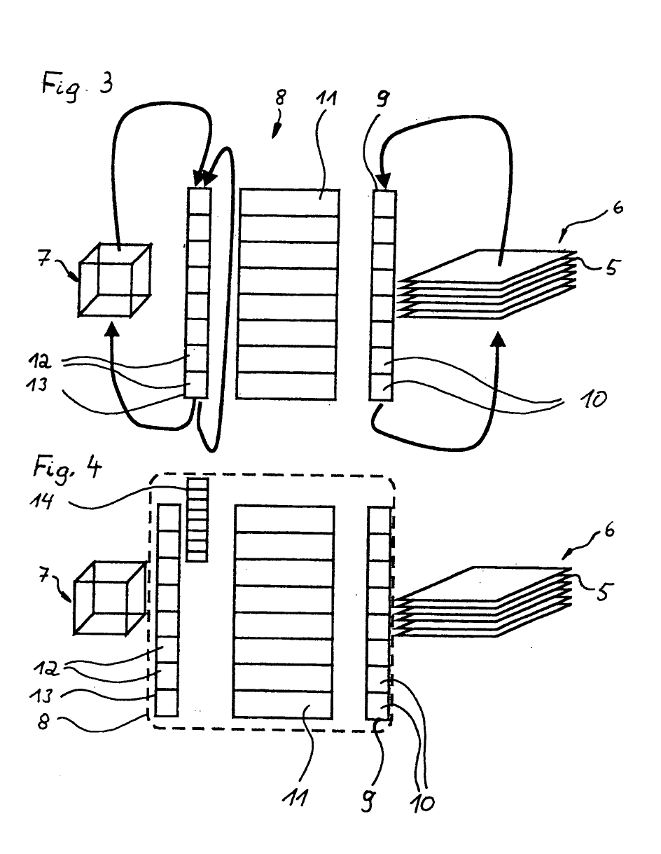

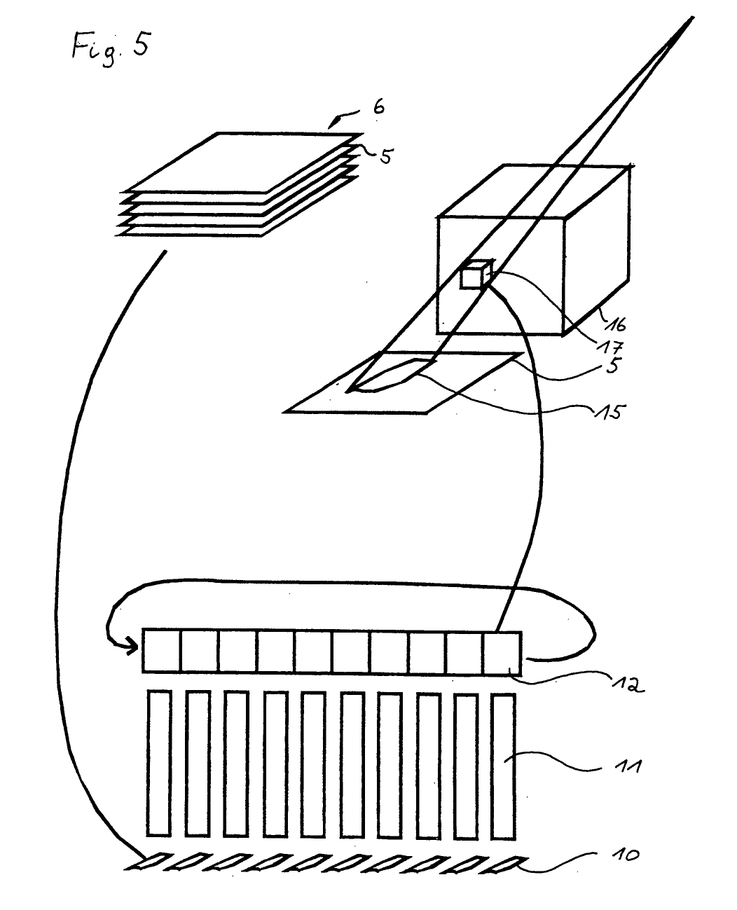

FIG. 3 a schematic computer architecture for the back-projection;

FIG. 4 another computer architecture for the back-projection;

FIG. 5 a schematic representation of the computer structure according to FIG. 3, with the link between volume and projection;

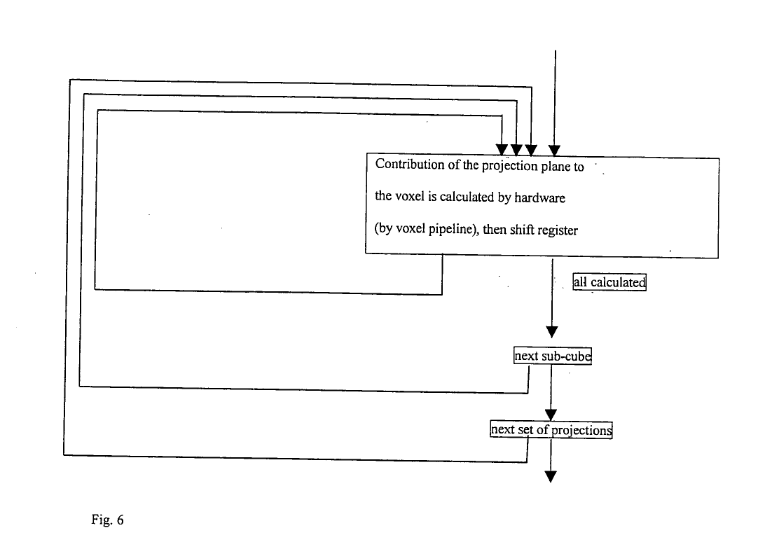

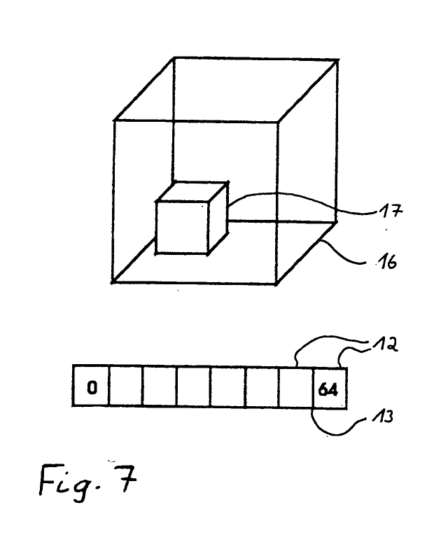

FIG. 6 a process sequence with the computer architecture according to FIGS. 3 to 5;

FIG. 7 the selection of a sub-cube;

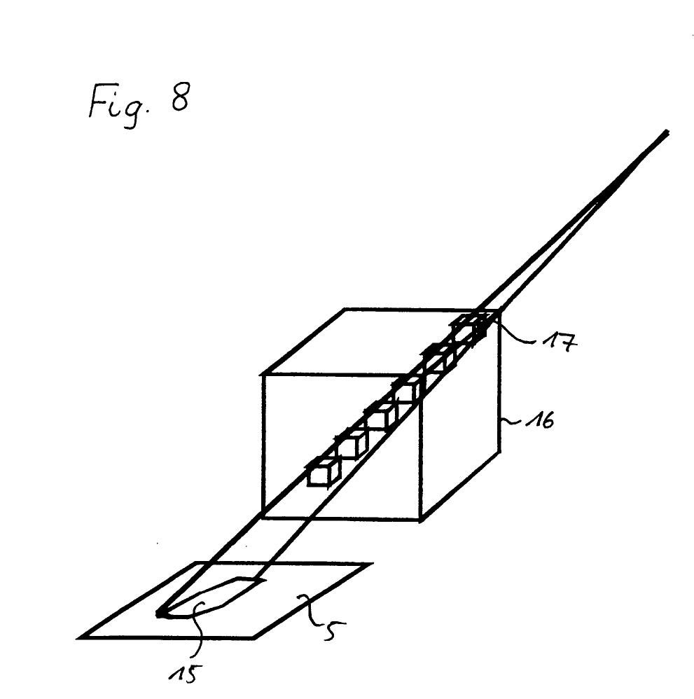

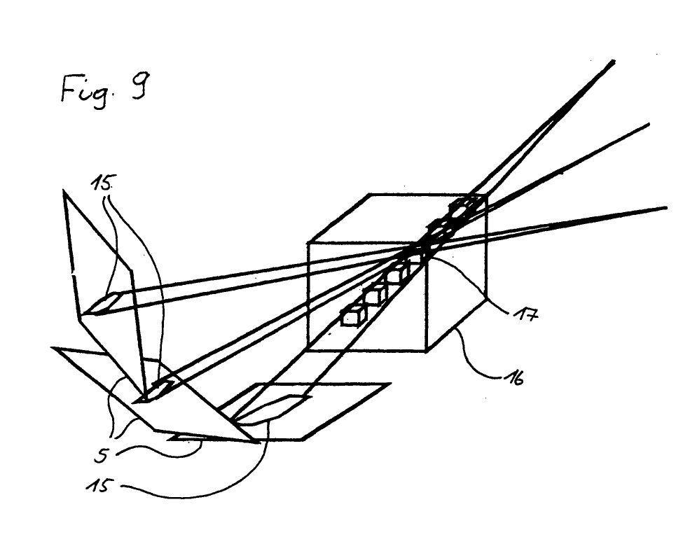

FIG. 8 the selection of suitable regions for a number of several sub-cubes, i.e. voxels;

FIG. 9 several projection planes for a sub-cube;

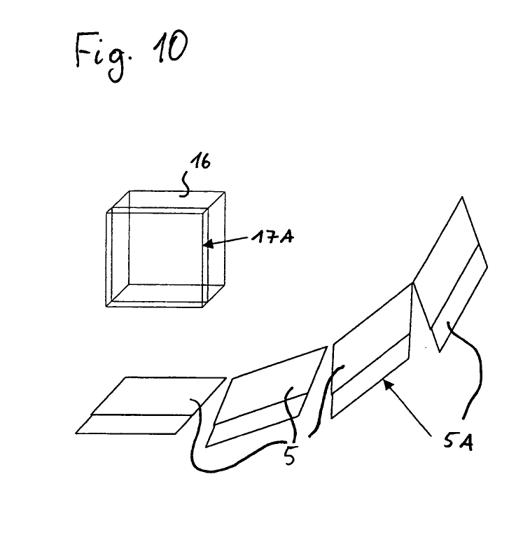

FIG. 10 a possible arrangement of projections and the image space to be reconstructed;

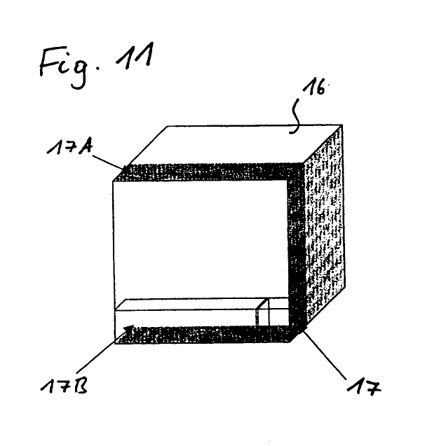

FIG. 11 the selection of a voxel slice, a voxel line selected in the voxel slice, and of a voxel cube selected in the voxel line;

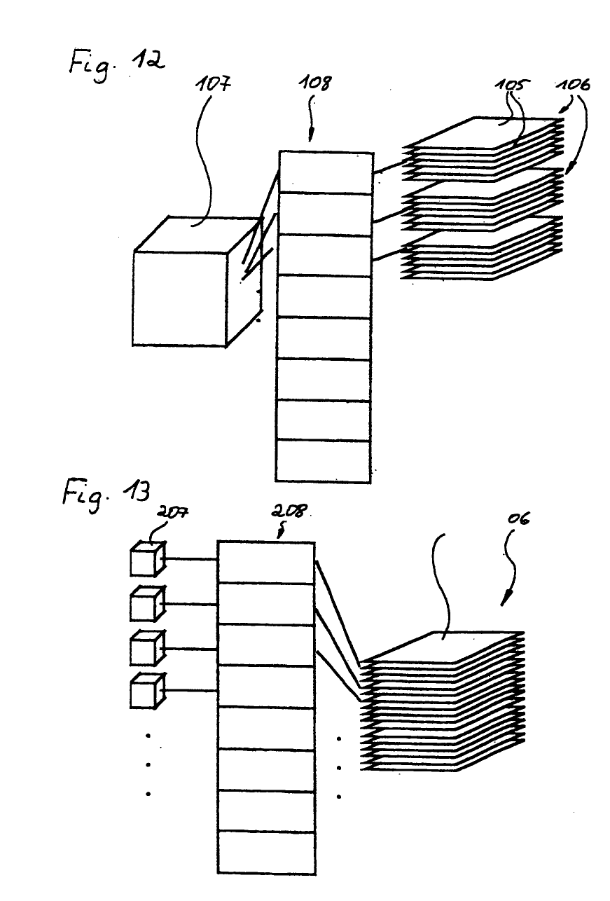

FIG. 12 a computer structure according to the state of the art, having several parallel projection memory units; and

FIG. 13 a computer structure according to the state of the art, having several parallel memory units for the intensity data.

In the X-ray system shown schematically in FIGS. 1 and 2, a person 1 is X-rayed by means of a radiation-source 2. In this way, projections 3 can be taken with a corresponding detector, and these, in the final analysis, reflect the interaction of the corresponding beam cone 4 with the body of the person being X-rayed. The radiation source 2 and the corresponding detector are arranged so that they can rotate around the person, so that different projection directions can be taken. It is understood that instead of such a system, other systems, in which a back-projection is necessary, can also be used. In particular, objects can also be examined analogously.

The projections 5 that are determined are stored in a corresponding memory 6 for the acquired projections. A spatial volume image is to be produced from them, which image is stored in a memory 7 for the reconstructed spatial volume image (see FIGS. 1 to 5).

The two memories 6 and 7 are linked with one another by means of a data processing unit 8, whereby the data processing unit 8 comprises a projection cache 9 in the exemplary embodiments shown in FIGS. 3 and 4. As needed, data from the projection memory 6 can be stored in this projection cache 9. The projection cache 9 has individual memory segments 10, in which pixel data of a projection plane that have been transmitted, in each instance, are stored. A hardware pipeline, i.e. processing pipeline 11 is provided per memory unit 10, which pipeline is assigned to a cell 12 of a voxel cache 13 that is structured as a shift register. The hardware pipeline 11 reads the required projection pixels out of the projection memory 9 for the volume element stored in the memory 12. It then calculates the contribution for the volume element, which is added to the previous contribution of the volume element. In this connection, in the present exemplary embodiment, the intensities along the beams “source projection pixels” are uniformly distributed over the voxels in question, for a back-projection, whereby, depending on the concrete embodiment, another function can also be provided, which takes geometric weakening into consideration.

In this connection, it must be calculated for every voxel, proceeding from every projection, at what point the center of the voxel is to be imaged. The intensity of the point in the projection plane 5 is generally calculated by means of bilinear interpolation of the adjacent pixel intensities. The value determined is then multiplied by the inverse square of the “voxel-source” distance and added to the previous contribution in the voxel.

Since all the hardware pipelines 11 work synchronously, they are finished at the same time. The results in the shift register 13 are then pushed along by one memory element 12, so that the contribution of the next projection plane is calculated for every volume element.

Once the contributions of all the projection planes have been calculated and accumulated, the data in question are written back into the memory 7.

In order not to allow the time for re-storing as well as new storing of the data in question from the voxel cache 13 to the memory 7 to elapse uselessly, a second voxel cache 14 is provided in the embodiment according to FIG. 4, which is connected with the hardware pipelines 11 during the re-storing processes of the first voxel cache 13. In this way, the parallel processors of the hardware pipelines 11 are utilized in optimum manner. During the calculation of the voxels stored in the cache 14, the voxel cache 13 is emptied and reloaded accordingly, so that it is then available for additional calculations, as soon as the calculations for the data in the voxel memory 14 have been concluded. Then the voxel memory 13 is connected with the hardware pipelines 11, while the data exchange with the memory 7 is undertaken for the voxel memory 14.

It is true that it is possible that all of the data of a projection plane 5, in each instance, are read into the projection cache 9. However, since the volume of the voxel cache 13 is limited, a large number of redundant data would be loaded, because only very small regions can become relevant for a certain voxel per projection. In this regard, it is advantageous to load only such regions as those designated with the number 15 in FIG. 5, for example. In the present connection, the term “region” is understood to mean a relatively small amount of pixels, preferably pixels that are connected in simple manner, whereby the size of the amount is selected in such a way that this pixel amount can easily be loaded into the projection cache 9.

Fundamentally, any desired voxels, i.e. projections 5 or regions 15, can be loaded into the projection cache 9 and in the voxel cache 13 or 14, respectively. Preferably, however, the regions 15 read into the projection cache 9 are correlated with one another. The correlation can be selected in such a way that a sub-cube 17 is selected from the image space 16 to be reconstructed, the number of voxels of which preferably corresponds to the number of memory elements 12 in the voxel cache 13 or 14. A sub-cube 17 with an edge length of four voxels is shown as an example in FIG. 7; it can be stored in memory in a voxel cache 13 having 64 memory elements.

Then, all the regions 15 that contain the relevant image data, in each instance, corresponding to the projection direction, in each instance, are loaded into the projection cache 9, as this is shown in FIGS. 5 and 9, as an example. As soon as the corresponding projection data have been loaded, the calculations, in each instance, can be carried out, whereby all of the voxels of the sub-cube 17 are calculated in parallel for the regions 15 loaded in the projection cache 10, in each instance, by means of the shift register. It is true that ideally, all of the projection directions are stored in memory in the projection cache 9. However, a cost-benefit comparison can be performed, since only part of the required projections 5 is stored in memory in the projection cache 9, and a corresponding data exchange is planned for the interim period.

The process sequence that has therefore been carried out is shown in FIG. 6. First of all, it is determined what regions 15 of the projection plane 5 make a contribution to a corresponding sub-cube 17. This can already take place during the program installation and/or during the design of the hardware structure. Subsequently, all of the contributions of the projections for a corresponding voxel are determined for a sub-cube in an inner loop, in each instance, whereby the sub-cube 17 is processed by means of the shift register 13. Subsequently, an additional sub-cube 17 is selected, whereby if possible, the regions taken into consideration in this connection are maintained and only individual regions 15 need to be selectively exchanged. If necessary, however, the set of regions 15 can be completely replaced.

Since it is assumed, in the present exemplary embodiment, that the number of projections 5 exceeds the number of memory units 10 of the projection cache 9, a completely new set of projection directions, i.e. projections 5 is selected when all of the sub-cubes 17 of the volume 16 have been processed, and the contributions of these projections are determined analogously.

In a concrete embodiment variant, the reconstruction method is essentially based on two steps: first, the data are filtered, then the back-projection is carried out. Without limiting the general applicability, it can be assumed, in this connection, that the X-ray system has rotated about an axis that is parallel to the normal of one of the lateral surfaces of the volume cube, i.e. the image space 16 to be reconstructed (see FIG. 10). In the back-projection step, voxel slices 17A with a thickness N can then be considered separately, parallel to this lateral surface, and the projections 5 can be reconstructed from corresponding projection lines 5A (numbered as examples in FIG. 10). From these slices, voxel cubes 17 having a size of N×N×N can be read, according to FIG. 11, whereby this preferably takes place iteratively by voxel lines 17B.

The contribution of a stack of N×N×N projections (projection block) to each of the voxels of this read-out cube is calculated and added to the current value of the voxels.

The projections 5 can then be utilized for calculating the individual voxels, in their lines 5A that are relevant for a voxel slice 17A, in each instance. In particular, when the parts of the projections 5 that relate to the voxel cube slice 17A, in each instance, are loaded for all projections 5, the contribution to the total voxel cube slice 17A can be calculated. Therefore each pipeline 11 preferably contains sufficient memory for these data. On the basis of this suitable assignment of projections to volumes, it can be assumed that these are several adjacent lines in the projection image. In order for the method to work even more efficiently, the individual lines are preferably reloaded during the calculation (2-way memory), in order to avoid access conflicts, or several memory banks are used.

The size of the memory is preferably approximately the cube width times the side length of the projection image (typically 512 or 1024) values (typically 16 bit). The voxel cube width is typically 4 (since 64 pipelines correspond to 4×4×4), i.e. for each pipeline, a buffer having a size of 4×2 Bytes×1024=8 kBytes is required, in other words a total of 512 kBytes buffer memory. Preferably, 8 multipliers are used for each of the 64 pipeline steps, i.e. 512 multipliers in total.

The calculation sequence then preferably looks as follows:

For each slice having the thickness N // back-projection step

For each projection block

write the lines that are required for the slice into the projection
cache
For each cube having the size N × N × N of the slice

read the cube into the shift register having N × N × N
registers
perform N × N × N times

shift the voxels in the shift register forward by one
position
Parallel: for each shift register

calculate the contribution of the related
projection plane to the voxel in the register
add this contribution to the voxel

write the cube back to the volume memory

In this regard, cubes and lines of several projections can be kept loaded at the same time, in particular, and by way of the shift register, each voxel of the cube can be brought together with each of the loaded projections. This has the advantage that the calculated slice is complete, after all the projections have been run through, and that almost all of the used lines of the projections no longer need to be loaded.

Exemplary embodiments according to the state of the art are shown in FIGS. 12 and 13, whereby these have parallel structures 108 and 208, respectively, in each instance, but either the projection planes 105 are stored in several memory units 106, or the voxel spaces 207 are stored in parallel memory units, causing the costs to increase significantly.

The present invention can be implemented, for example, in a C-arm angiography system or in a linear acceleration unit in connection with an electronic portal imaging device (EPID). The reconstruction can take place, for example, by means of a filtered back-projection or by means of imperative [sic—should be iterative] methods. For the filtered back-projection, the projection data are first weighted as a function of their location, and subjected to filtering. When filtering is implemented in the frequency space, using a well-optimized software for Fourier transformation, the step can be viewed as being relatively non-time-critical. For back-projection of the filtered profiles, these as well as a volume data set initialized with zero are first loaded into the memory of the corresponding system card. The back-projection takes place as described above. With the iterative method for image reconstruction, a projection operation as well as a back-projection operation is contained in every step. Special methods and architectures are already known for implementing an efficient projection operation (ray-tracing). The method described above, as well as the device described above, can be used for a voxel-based back-position [sic—should be back-projection].

Large data amounts can be processed and reconstructed in timely manner by using the architecture described above, so that the positioning of a patient in a linear accelerator can be verified on-line, for example, with the system described, by means of high-energy CT.

1. Method for reconstructing an image in a spatial volume on the basis of acquired projections, wherein during a reconstruction step, each acquired projection or each region of an acquired projection is fed once into a data processing unit (8) from a memory (6) for the acquired projections, and the intensity of a voxel of the reconstructed spatial volume image is updated during the reconstruction step for each voxel-relevant projection or region.

2. Method according to claim 1, characterized in that several projections or regions of projections are processed in parallel.

3. Method according to claim 1 or 2, characterized in that the projections or regions of projections are loaded into a projection cache (9) for processing.

4. Method according to one of claims 1 to 3, characterized in that in a sub-step of the image reconstruction, a sub-cube (17) is processed, the intensity data of which are stored in a voxel cache (13), and updated during the processing, on the basis of data of the projections.

5. Method according to one of claims 1 to 3, characterized in that in a sub-step of the image reconstruction, a selection (17) of voxels is processed, the projection of which is imaged on a similar region (15) of a projection plane.

6. Device for reconstructing an image in a spatial volume (7) on the basis of acquired projections (5), having a memory (6) for the acquired projections and a memory (7) for the reconstructed spatial volume image, which are linked with one another by means of a data processing unit (8), characterized in that the data processing unit (8) comprises at least two processing pipelines (11), which are each connected with at least one memory region (10) of a projection cache (9), on the one hand, and with at least one memory region (12) of a voxel cache (13), on the other hand, whereby the voxel cache (13) is linked with the memory (7) for the reconstructed spatial volume image, and the projection cache (9) is linked with the memory (6) for the acquired projections.

7. Device according to claim 6, characterized in that the voxel cache (13) is structured as a shift register.

8. Device according to claim 6 or 7, characterized by at least a second voxel cache (14), which can be connected with the processing pipeline (11), as an alternative to the first voxel cache (13), and can exchange data with the memory (7) for the reconstructed spatial volume image, independent of the first voxel cache (13).

9. Device for reconstructing an image in a spatial volume (7) on the basis of acquired projections (5), having a memory (6) for the acquired projections and a memory (7) for the reconstructed spatial volume image, which are linked with one another by means of a data processing unit (8), characterized in that the memory bandwidth lies below the processing output.
